(19) United States
(12) Patent Application Publication
(10) Pub. No.: US 2024/0369729 A1
(43) Pub. Date: Nov. 7, 2024

(54) A METHOD AND SYSTEM FOR DETERMINING FIRST BREAKS OF SONIC WAVEFORMS

(71) Applicant: SAUDI ARABIAN OIL COMPANY, Dhahran (SA)

(72) Inventors: Wei Li, Beijing (CN); Chris B. Ayadiuno, Dhahran (SA)

(73) Assignees: SAUDI ARABIAN OIL COMPANY, Dhahran (SA); ARAMCO FAR EAST (BEIJING) BUSINESS SERVICES CO., LTD., Beijing (CN)

(21) Appl. No.: 18/247,399

(22) PCT Filed: Mar. 28, 2022
(86) PCT No.: PCT/CN2022/083249

§ 371 Date: Mar. 30, 2023

(51) Int. Cl. G01V 1/50

(52) U.S. Cl. CPC G01V 1/50; G01V 2210/6222

(57) ABSTRACT

A method and system for determining a set of final first breaks (390) of a sonic dataset (250) are disclosed. The method includes determining a sonic slowness log from the sonic dataset (250) and for each trace recorded by a subset of the plurality of receivers (101-113) determining an initial first break estimate (410) for each trace, and determining a second first break estimate (510) based on an energy ratio within a time window surrounding the initial first break estimate (410). The method further includes, for each of the plurality of traces in the sonic dataset (250), predicting a refined first break estimate (610, 620, 630) based, at least in part, on the second first break estimates (510), the sonic slowness log, and an inter-receiver distance, and determining the set of final first breaks (390) of the sonic dataset (250) by applying a time shift to the refined first break estimates.

### BACKGROUND

Borehole acoustic monopole radial profiling based on recorded waveforms inverts travel times to generate two-dimensional (2D) slowness profiles. Results of monopole radial profiling analysis enables engineers or geologists to estimate horizontal changes in velocity deep into formation. First break picking is an important step in a monopole radial profiling workflow. However, conventional manual first break picking, including repeated tracking, picking, and editing of first break for a plurality of receivers, is a time-consuming step taking many hours.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for determining a set of final first breaks of a sonic dataset are disclosed. The method includes determining a sonic slowness log from the sonic dataset and for each trace recorded by a subset of the plurality of receivers determining an initial first break estimate for each trace, and determining a second first break estimate based on an energy ratio within a time window surrounding the initial first break estimate. The method further includes, for each of the plurality of traces in the sonic dataset, predicting a refined first break estimate based, at least in part, on the second first break estimates, the sonic slowness log, and an inter-receiver distance, and determining the set of final first breaks of the sonic dataset by applying a time shift to the refined first break estimates.

In general, in one aspect, embodiments relate to a non-transitory computer readable medium storing instructions executable by a computer processor, the instructions including functionality for determining a sonic slowness log from a sonic dataset composed of a plurality of traces and for each trace recorded by a subset of the plurality of receivers determining an initial first break estimate for each trace, and determining a second first break estimate based on an energy ratio within a time window surrounding the initial first break estimate. The instructions further include, for each of the plurality of traces in the sonic dataset, predicting a refined first break estimate based, at least in part, on the second first break estimates, the sonic slowness log, and an inter-receiver distance, and determining the set of final first breaks of the sonic dataset by applying a time shift to the refined first break estimates.

In general, in one aspect, embodiments relate to a system for determining a set of final first breaks of a sonic dataset obtained from a sonic tool moveable within a wellbore, wherein the sonic tool comprises a source and a plurality of receivers each separated by a unique source-receiver distance, and the sonic dataset includes a plurality of traces each corresponding to a unique combination of one of the plurality of receivers and one of a plurality of source activation locations in the wellbore. The system includes a sonic tool to acquire the sonic dataset, a logging acquisition system to record the sonic dataset, and a processor configured to determine a sonic slowness log from a sonic dataset composed of a plurality of traces and for each trace recorded by a subset of the plurality of receivers determine an initial first break estimate for each trace, and determine a second first break estimate based on an energy ratio within a time window surrounding the initial first break estimate. The processor is further configured to, for each of the plurality of traces in the sonic dataset, predict a refined first break estimate based, at least in part, on the second first break estimates, the sonic slowness log, and an inter-receiver distance, and determine the set of final first breaks of the sonic dataset by applying a time shift to the refined first break estimates.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a sonic tool and radial profiling diagram in accordance with one or more embodiments.

FIG. 2 shows a sonic waveform (“trace”) and an initial first break estimate in accordance with one or more embodiments.

FIG. 3 shows a flowchart in accordance with one or more embodiments.

FIG. 4 shows an example expanding on one or more of the steps showing in FIG. 3.

FIG. 5 shows an example expanding on one or more of the steps showing in FIG. 3.

FIGS. 6A-6C show examples expanding on one or more of the steps showing in FIG. 3.

FIGS. 7A-7C show examples expanding on one or more of the steps showing in FIG. 3.

FIGS. 8A-8C shows an example expanding on one or more of the steps showing in FIG. 3.

FIG. 9 shows a system in accordance with one or more embodiments.

FIG. 10 shows a system coupled to a computing device in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments are enclosed herein for determining the arrival time (“first break”) of the first pulse of sonic energy radiating from a sonic source and detected at a sonic receiver of a wellbore sonic tool. Further, embodiments are disclosed for using the resulting first breaks from a plurality of source locations and a plurality of receivers to determine the variation of sonic wave propagation velocity or slowness along the axis of the wellbore and radially away from the wellbore into the surrounding rock formation.

First break picking refers to the detecting or picking the onset arrivals of refracted signals from all the signals produced and received by a sonic tool comprising a source and a plurality of receivers. The conventional first break picking procedure is a time-consuming step that may take many hours to complete. This disclosure provides a procedure that significantly reduces the first break picking time by at least 70%. Specifically, instead of estimating first break for every receiver, this disclosure provides a procedure that estimates a final first break for all receivers based on a plurality of first break estimates for a subset of the plurality of receivers only.

In general, embodiments of the disclosure include a system and a method that aims at estimating a final first break for a plurality of receivers by applying an initial first break estimate, a weighted interpolation-based algorithm, and a time-shift. More specifically, in accordance to one or more embodiments, the method may use a plurality of information to predict initial first break estimates for the plurality of receivers. Further, the method may use an energy ratio (ER) method to obtain second first break estimates based on the initial first break estimates. Further, in accordance to one or more embodiments, the method may determine refined first break estimates based on the second first break estimates and by performing the weighted interpolation-based algorithm. Furthermore, in some embodiments, the method may determine final first break estimates for the plurality of receivers based on the refined first break estimates and by applying the time shift.

In some embodiments, the method may be used to determine the radial variation of sonic slowness around the wellbore based on the tomographic inversion of the final first breaks estimates.

Specifically, according to Hornby, B. E., TOMOGRAPHIC RECONSTRUCTION OF NEAR-BOREHOLE SLOWNESS USING REFRACTED BOREHOLE SONIC ARRIVALS, 1993, a formation's properties may be assumed to vary radially away from the wellbore and axially along the wellbore but to be invariant with azimuth in the near borehole region. Let x=(xᵣ, x_{z}) denote radial and vertical coordinates within the rock volume and let u(x) be the unknown slowness function. Further, assuming that there are N receivers in the sonic tool and the dataset consists of L source positions with all N receivers recorded at each source activation location. The total number of signal paths in the dataset is K=LN. First breaks recorded at the receivers are denoted by tₖ, k=1, . . . , K. each tₖ may be written as tₖ=∫_{T}_{ₖ}₍ᵤ₎u(x)ds, where ds is arc length and Tₖ(u) denotes the ray path, connecting source and receiver.

Inversion may involve a sequence of ray tracing and first break calculation followed by linear inversions. The system may be first linearized by the use of an current slowness model ū. The first current slowness model may be an initial slowness model estimated from computations of fluid slowness, borehole diameter, and virgin formation slowness. First breaks produced by the current slowness model may be calculated as t̅ₖ≈∫_{T}_{ₖ}_{(ū)}ū(x)ds. A system of linear equations may be constructed based upon the difference between the calculated first breaks of the current slowness model, the observed first breaks, and discretized approximations to the current slowness model and the ray path. The current slowness model may be updated based on the solution to the system of linear equations and the process repeated with the new current slowness model.

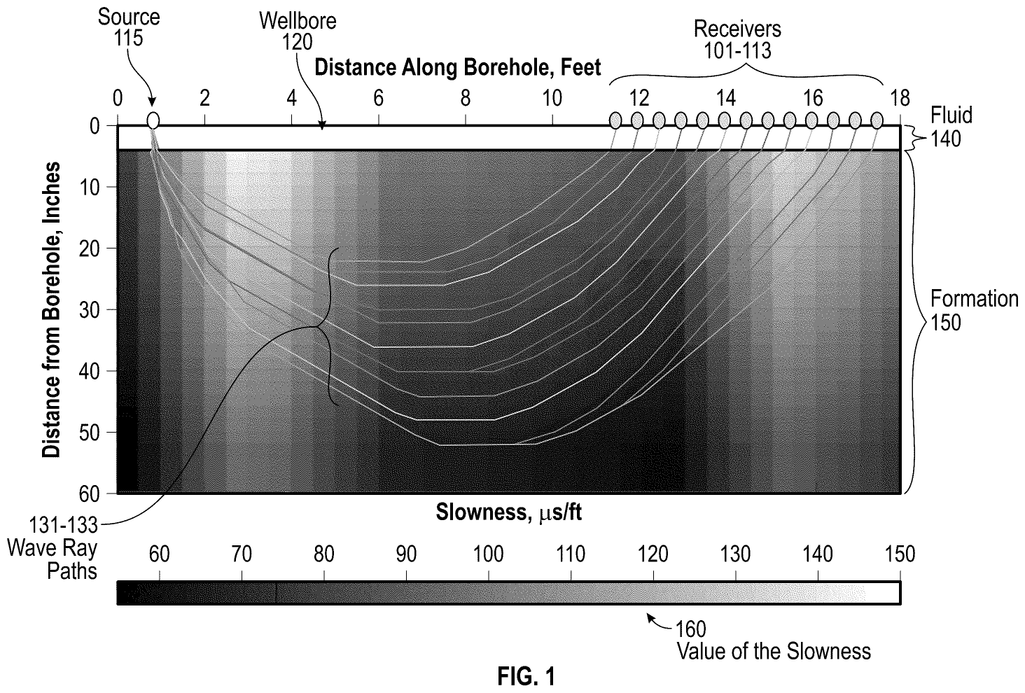

FIG. 1 shows a schematic diagram in accordance with one or more embodiments. FIG. 1 shows a borehole (120), a sonic tool, and a radial profile through a formation (150). The sonic tool includes at least one source (115) and a plurality of receivers (from left to right, 101-113). In some embodiments the receivers (101-113) are evenly spaced as depicted in FIG. 1. In other embodiments (not shown) the receivers may be unevenly spaced. Although 13 receivers are shown in FIG. 1, in some embodiments there may be a greater or lesser number of receivers. In FIG. 1, the Y axis of the figure depicts the distance from the wellbore center, wherein the top edge at 0 refers to the wellbore center. The X axis of the figure depicts the distance along the borehole. The receivers (101-113) are each spaced at a unique distance from the source (115).

The top of FIG. 1, Y=0, represents the wellbore axis. The sonic tool is depicted as being disposed along the axis of the wellbore. Below the sonic tool, the first layer represents a fluid (140) filling the wellbore, and the second layer below the fluid represents formation (150). The shade of the formation (150) represents a slowness (inverse of velocity) of sonic wave propagation, wherein the darker the shade of the background, the slower the velocity. The slowness may be the slowness of compressional waves generated by a monopole source. The grayscale (160) at the bottom of FIG. 1 indicates value of the slowness. The slowness may vary axially along the wellbore, i.e., along the X axis of FIG. 1 and the slowness may vary radially perpendicular, i.e. along the Y axis of FIG. 1.

In accordance to one or more embodiments, a group of wave rays may be generated by the source (115) and may penetrate into the formation (150) and be received by each of the plurality of receivers (101-113). FIG. 1 further shows wave ray paths (131-133) from the source (115) to the plurality of receivers (101-113), respectively. The receivers (101-113) record the sonic waves to form a portion of a sonic dataset. Further portions of the sonic dataset may be obtained by moving the sonic tool along the wellbore axis in increments of axial distance. Moving the sonic tool causes the source and receivers to move in unison, such that the unique distance between the source and each receiver remains unchanged, while the source moves from one source activation location to the next. The source may be activated, and the resulting sonic waves recorded, to form a further portion of the sonic dataset at each sonic source location after each incremental move along the wellbore axis. The resulting plurality of portions of the sonic dataset maybe combined to form the sonic dataset.

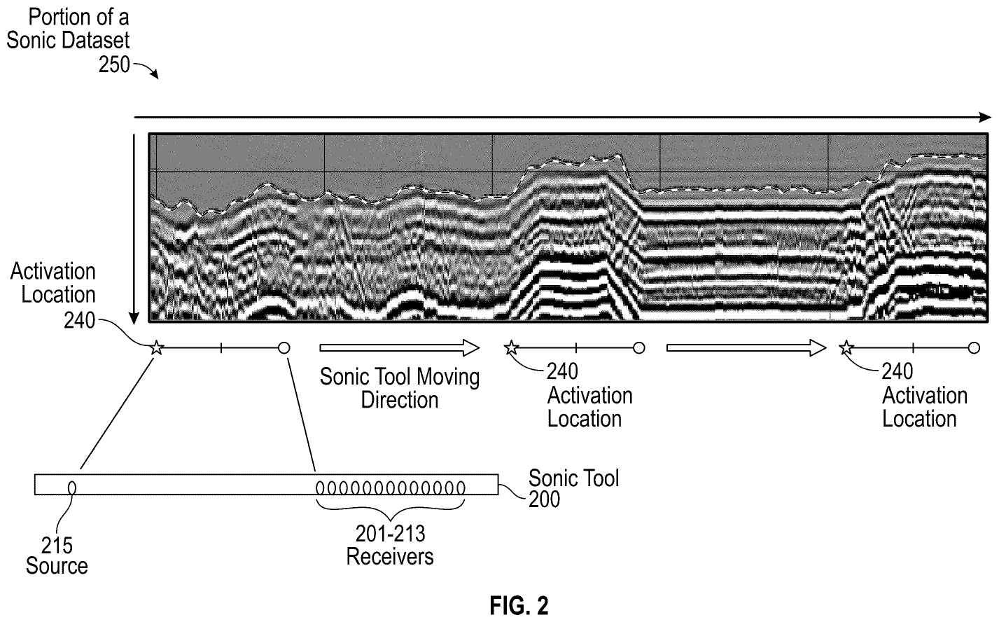

In particular, the sonic dataset comprises a plurality of traces each corresponding to a unique combination of one of the plurality of receivers and one of a plurality of source activation locations in the wellbore (120). Turning to FIG. 2, FIG. 2 shows an example of a plurality of traces comprising a portion of a sonic dataset (250), and an initial first break estimate. Each column of the portion (250) represents a trace with dark colors representing positive amplitudes of the pressure fluctuation generated by a sonic wave, and light colors representing negative amplitudes. The portion (250) represents a plurality of traces all recorded by one receiver at a fixed unique distance from the source (215). Each trace of the portion (250) represents a different source activation location.

As shown in FIG. 2, a source (215) and a plurality of receivers (201-213) are mounted in a sonic tool (200), which may be a steel pipe. The sonic tool is dragged along a wellbore, such as the wellbore (120) in FIG. 1. The activation location (also known as firing/excitation location) is the location at which the source (215) generates sound. As FIG. 2 shows, as the sonic tool (200) moves along the wellbore, the activation location of the source (240) changes along the wellbore.

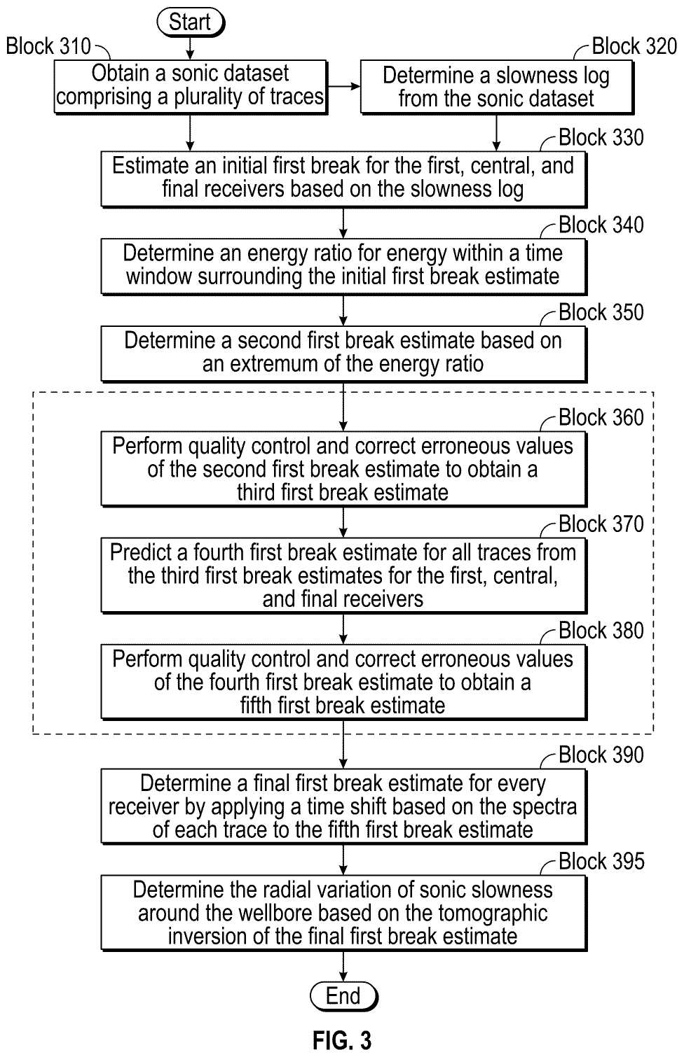

Turning to FIG. 3, FIG. 3 shows a flowchart in accordance with one or more embodiments. Specifically, FIG. 3 describes a general method for determine first break estimations for the plurality of receivers. More specifically, FIG. 3 describes detailed procedures of determining a set of final first break estimations based on a sonic dataset obtained from a sonic tool, such as the sonic tool (200) and the corresponding deployment as described in FIGS. 1 and 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 310, a sonic dataset comprising a plurality of traces are obtained by a plurality of receivers. For example, the sonic dataset may be obtained by the plurality of receivers (101-113 or 201-213) of the sonic tool (200) in FIGS. 1 and 2. Specifically, the plurality of traces each corresponds to a unique combination of one of the plurality of receivers and one of a plurality of source activation locations in a wellbore.

In Block 320, a slowness log is determined from the sonic dataset. A slowness log may be determined by estimating the slowness (the reciprocal of velocity) at which a sonic wave propagates across the receiver array, i.e., from receiver closest to the source (101) to the receiver farthest from the source (113), for each source location. Typically, a value of the sonic log may be determined for each source activation location. The source activation locations may be spaced at equal intervals of 6 inches (15 cm), however in some embodiments they may be unequally spaced. Each sonic log value may be determined from a single activation of the source by calculating a measure of similarity between two traces recorded by two receivers, e.g., receivers 101 and 102, after time-shifting at least one of the traces by an amount determined by the separation between the two receivers and a candidate slowness. The calculation of the similarity may be repeated for a plurality of combinations of receiver pairs, e.g., receivers 101 and 102, receivers 102 and 103, receivers 101 and 103, etc., and the measure of similarity summed over pairs of receivers. The value of one point of the slowness log may then be determined by identifying the candidate slowness that has a maximum value of the measure of similarity.

In Block 330, an initial first break is estimated for each trace from a subset of the plurality of receivers. The subset of the plurality of receivers may be the first, central, and final receivers. The initial first break may be estimated based on the slowness log. In particular, the first receiver may be a near-receiver located nearest to the source; the last receiver may be a far-receiver located farthest from the source; the central receiver may be at least one receiver located between the near-receiver and the far-receiver, and may be the middle receiver between these two. In accordance to one or more embodiments, the initial first break estimates may be determined based the unique source-receiver distance for each receiver, the sonic slowness log, a wellbore diameter, and a mud slowness using equation (1).

$${TT}_{n}^{1} = {\sum }_{i = 1}^{i = m ( n )} {x}_{i} * {dtc}_{i} ( n = 1 , 2 , ... , N ; {x}_{i} ∈ [ {S}_{0} , {R}_{N} ] ) \qquad ( 1 )$$

wherein, xᵢ is the increment between the i-th and i+1 th samples of the slowness log, dtcᵢ is the value of the i-th sample of the slowness log, m(n) is the number of slowness log samples lying between the source and the n-th receiver, S₀ is source activation location; Rₙ is the location of the n^{th} receiver; and TTₙ¹ is the initial first break estimate for the receiver Rₙ.

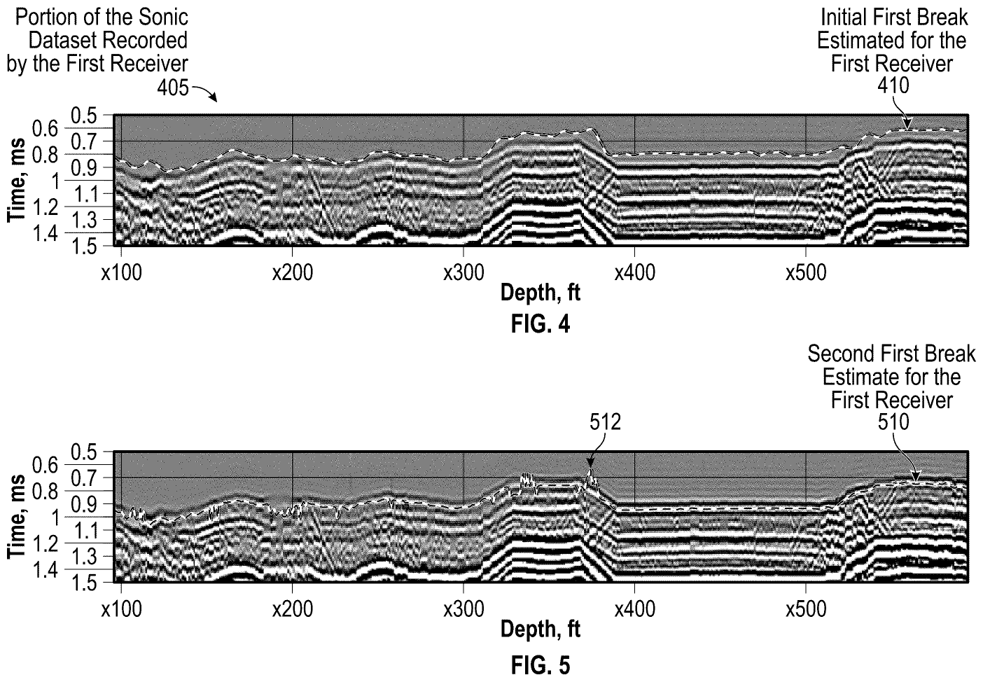

For example, FIG. 4A shows a portion of the sonic dataset recorded by the first receiver (405) and the initial first break estimates for the first receiver, TT₁¹ (410). As shown in FIG. 4, the initial first break estimate for the first receiver (410) is overlaid on the portion (405) received by the first receiver. In some embodiments, the portion (405) may have been processed by a band pass filter to remove unwanted noise prior to display.

In Block 340, for each trace of the receiver subset, an energy ratio (ER) for each sample within a trial time-window surrounding the initial first break estimate may be determined. The duration of the trial time-window may be chosen such that it is several times the dominant oscillatory period of the sonic trace. For each sample in the trial time window a preceding time-window and a succeeding time-window may be determined. The preceding time-window may occur before the sample, and the succeeding time window may occur after the sample. For each sample and energy ratio may be determined as the ratio of the energy of the trace within the succeeding time-window to the energy of the trace within preceding time-window. For example, the energy ratio, ER(i), for the i-th sample may be given by:

$$ER ( i ) = ( {\sum }_{j = 1}^{i + {L}_{s}} {wave ( j )}^{2} ) / ( {\sum }_{j = i - {L}_{p}}^{i} {wave ( j )}^{2} ) \qquad ( 2 )$$

where wave(j) is amplitude of the j-th sample of the trace, Lₚ is the duration of the preceding time-window, and Lₛ is the duration of the succeeding time-window. In some embodiments, Lₛ and Lₚ may have equal values and in other embodiments they may have different values.

In Block 350, for each trace of the receiver subset, a second first break estimate based on an extremum of ER is determined. The extremum may be a maximum. The second first break estimate, TTₙ², may be a revised and more accurate estimate of a final first break value than the initial first break estimate TTₙ¹. Specifically the second first break estimate for the n-th receiver, TTₙ² may be the sample within the trial time-window with the largest ratio of energy in its succeeding time-window to energy in its preceding time-window. FIG. 5 shows the second first break estimate TT₁² (510) of the first receiver (101).

In Block 360, for each trace of the receiver subset, quality control may be performed to correct erroneous values of the second break estimate to obtain a third first break estimate. In some embodiments, the quality control may be performed automatically and other embodiments the quality control may be performed manually. In still further embodiments, quality control may be performed using a combination of manual and automatic methods. For example, in accordance with one or more embodiments, the second first break estimates, TTₙ², may be automatically compared to the time of the first peak of the trace to exceed a predetermined value. When the second first break estimate differs from the time of the first peak by more than a predetermined time interval as at point (512) of FIG. 5 the second first break estimate may be manually corrected. The quality controlled second first break estimate, including any corrections made manual or automatically, for receiver Rₙ may be termed a third first break estimate, TTₙ³.

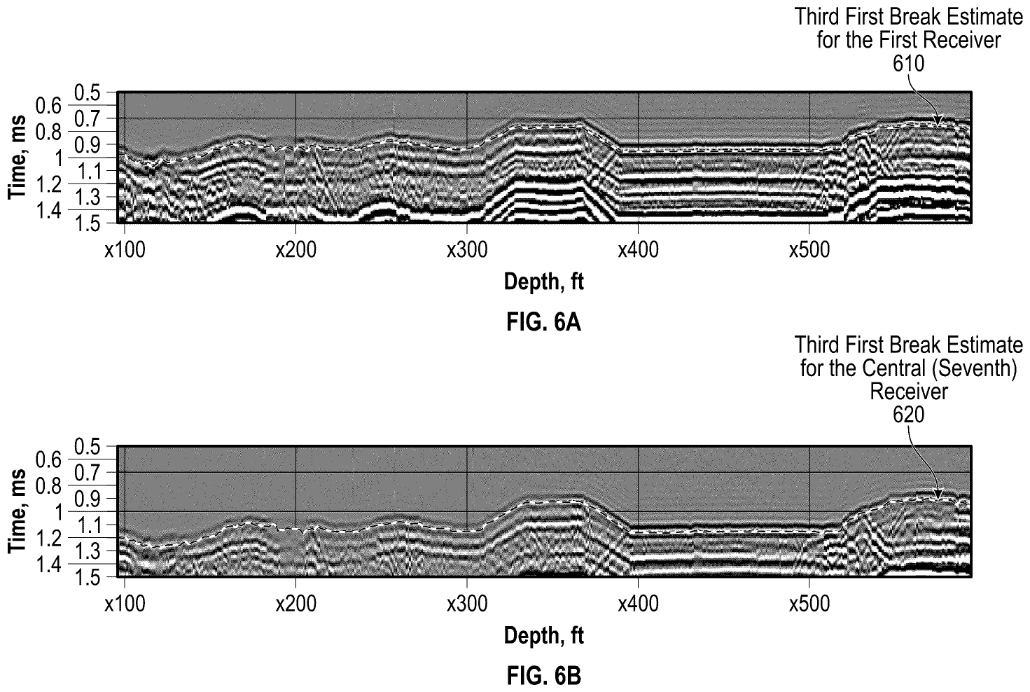

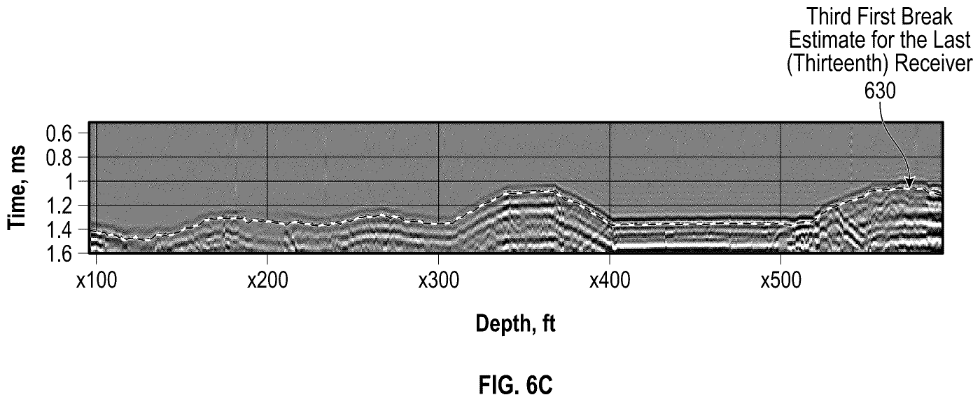

In accordance with one or more embodiments, the third first break estimate may be predicted automatically for each trace of the plurality of receivers identified as requiring correction by the quality control process based on the second first break estimates of the receiver subset. For example, the third first break estimate may be calculated as:

$${TT}_{n + 1}^{3} = {TT}_{n}^{2} + {dtc}_{n + 1} * dx \qquad ( 3 )$$

wherein dtcₙ₊₁ is the compressional slowness at n^{th} receiver location and dx is the receiver spacing. For example, FIGS. 6A-6C show the third first break estimates for the first, central, and final receivers, respectively.

In Block 370, for each trace of the plurality of receivers, a fourth first break estimate may be predicted based on the third first break estimate of the receiver subst. Specifically, the procedures in Blocks 340-360 are repeated for the receiver subset, then a fourth first break estimate for each of the trace of the plurality of receivers may be predicted based on a weighted interpolation from the third first break estimates for the receiver subset. For example, a fourth first break estimate for each of the trace of the plurality of receivers may be predicted based on

$${TT}_{n}^{4} = \frac{( {TT}_{mid}^{3} - {TT}_{1}^{3} ) ( {\sum }_{j = 2}^{n} {dtc}_{j} )}{{\sum }_{i = 2}^{mid} {dtc}_{i}} n = 2 , 3 , ... , mid - 1 \qquad ( 4 )$$

$${TT}_{n}^{4} = \frac{( {TT}_{N}^{3} - {TT}_{mid}^{3} ) ( {\sum }_{j = mid + 1}^{n} {dtc}_{j} )}{{\sum }_{i = mid + 1}^{N} {dtc}_{i}} n = mid + 1 , mid + 2 , ... , N \qquad ( 5 )$$

where, TT_{mid}³ is the third first break estimate of a central receiver. In accordance with one or more embodiments, one or more of the fourth first break estimates, TTₙ⁴, determined using Equations (4) and (5) may not coincide with a local peak amplitude of the corresponding trace and the value of those non-coincident values of TTₙ⁴ may be modified to be the of the nearest local peak amplitude.

In Block 380, for each trace of the plurality of receivers, quality control may be performed to correct erroneous values of the relocated fourth first break estimate. Similar to the procedure in Block 360, in some embodiments, the quality control may be performed automatically and other embodiments the quality control may be performed manually. In still further embodiments, quality control may be performed using a combination of manual and automatic methods. For example, in accordance with one or more embodiments, the relocated fourth first break estimates may be automatically compared to the time of the first peak of the trace to exceed a predetermined value. When the relocated fourth first break estimate differs from the time of the first peak by more than a predetermined time interval, the relocated fourth first break estimate may be manually corrected. The quality controlled relocated fourth first break estimate, including any corrections made manual or automatically, for the receiver Rₙ may be termed a fifth first break estimate TTₙ⁵.

The Steps 360-380 together are to determine a refined first break estimate for each trace of the receivers. As such, the fifth first break estimate TTₙ⁵ may be referred as the refined first break estimate.

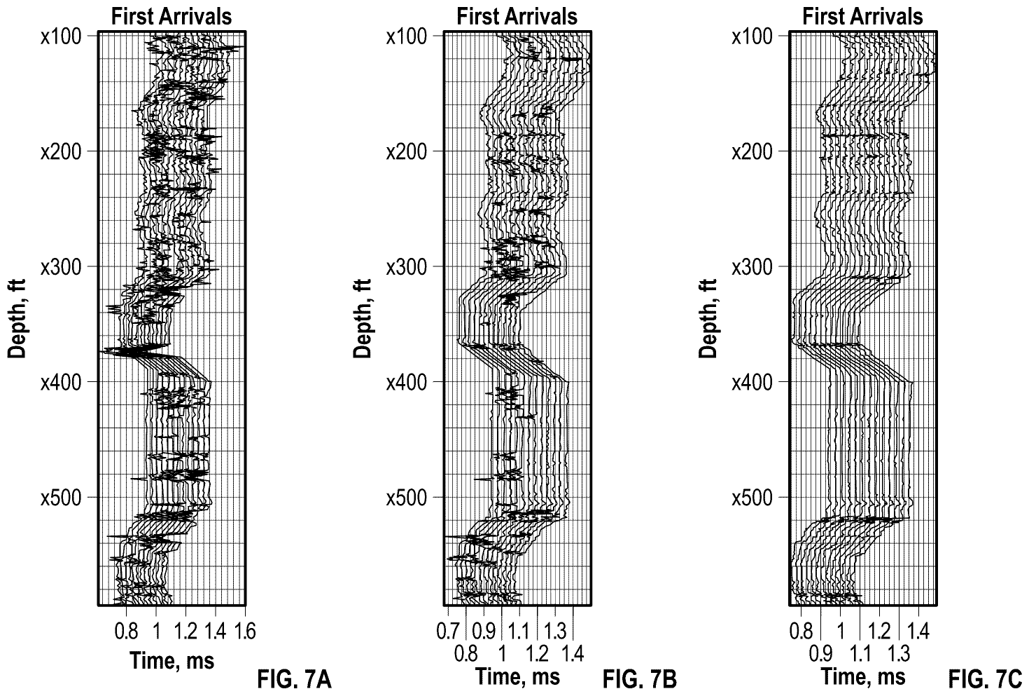

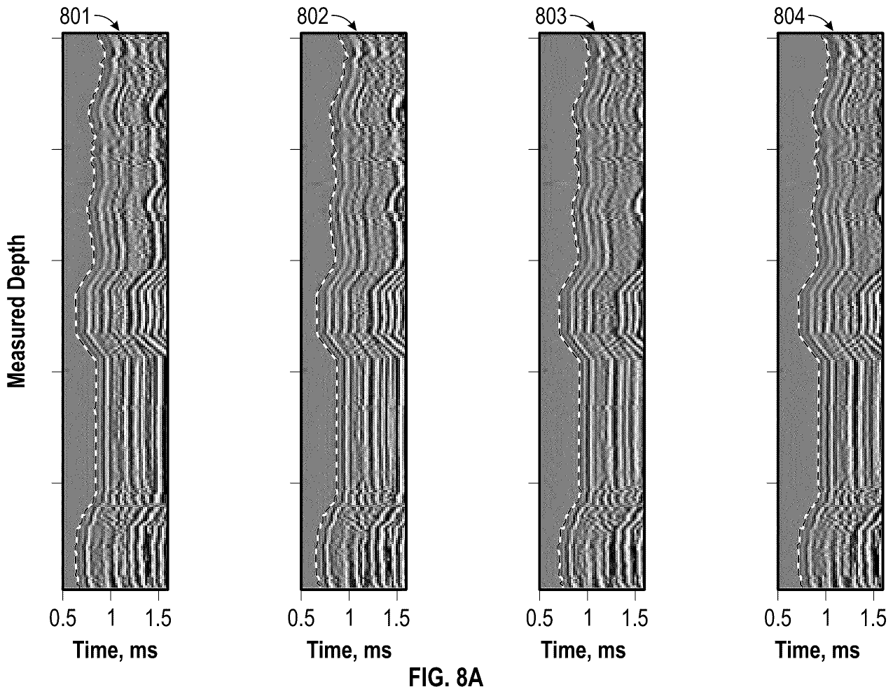

For example, FIGS. 7A and 7B each shows the synchronized second first break estimates TTₙ² and the third first break estimates TTₙ³ for all receivers (101-113) from FIG. 1. Comparing FIGS. 7A and 7B, mis-picks or errors in TTₙ³ appear much less than those in in TTₙ². FIG. 7C shows the TTₙ⁵ for these receivers (101-113), wherein mis-picks or errors in FIGS. 7A and 7B are corrected.

In Block 390, for each trace of the plurality of receives, a final first break estimate is determined by applying a time shift based on the spectra of each trace to the fifth first break estimate. More specifically, the final first break estimate is calculated by equation (6):

$${TT}_{n}^{final} = {TT}_{n}^{5} - \frac{1}{4 {f}_{ins}} , \qquad ( 6 )$$

wherein fᵢₙₛ is the instantaneous frequency of the trace at the fifth first break estimate TTₙ⁵. Specifically, the instantaneous frequency fᵢₙₛ is a local estimate of the dominant frequency of a waveform corresponding to the average frequency (centroid) of the power spectrum of a seismic wavelet. Thus, the final break estimate of each receiver is shifted earlier from the corresponding fifth first break estimate by ¼ of a dominant cycle of the trace.

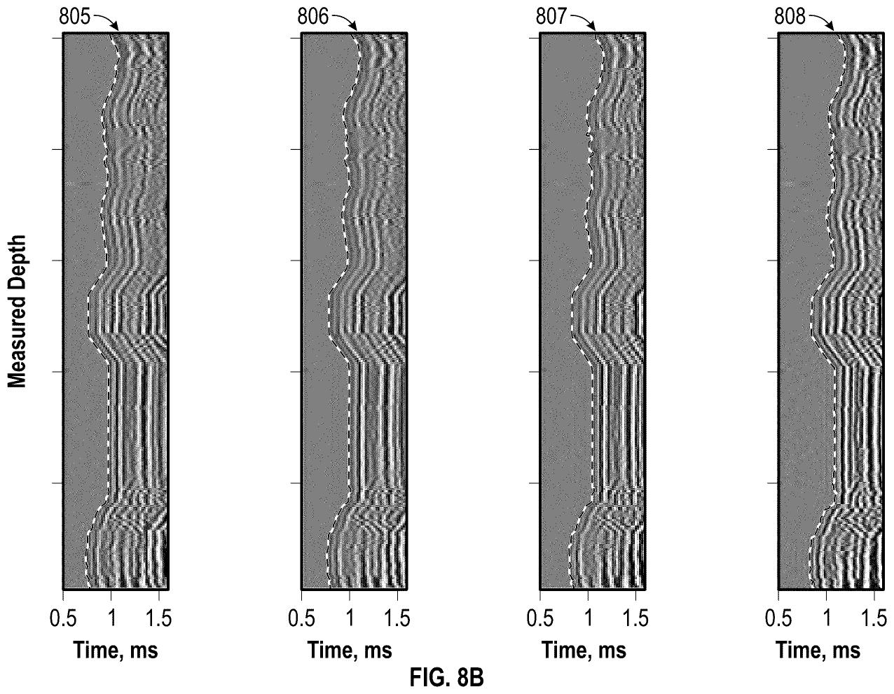

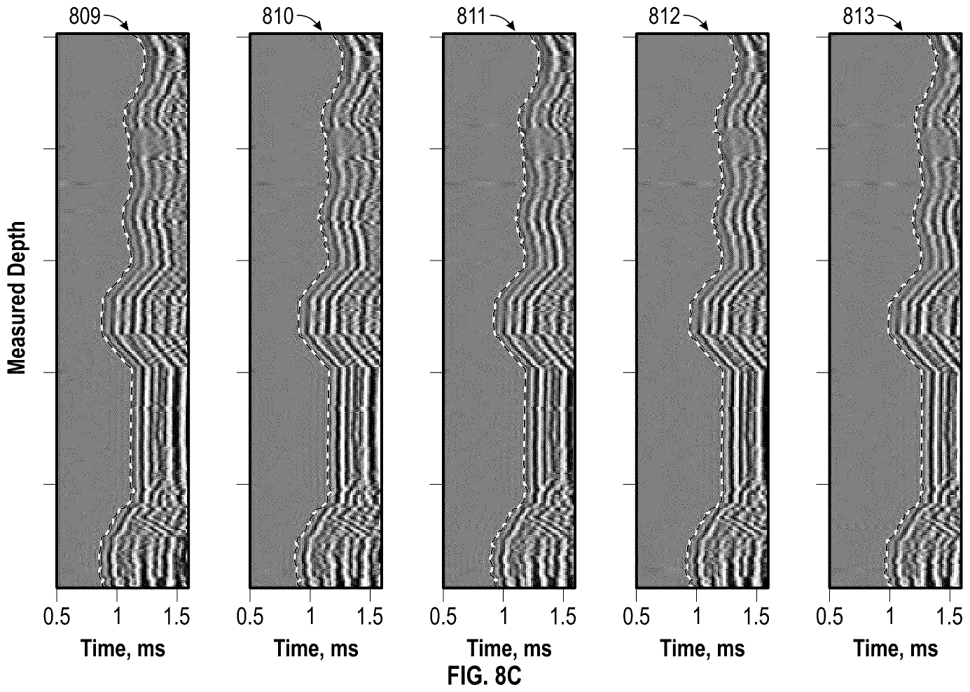

FIGS. 8A-8C show examples of the final first break estimates for receivers (101-113) as deployed in FIG. 1. Specifically, in FIG. 8A the final first break estimate for receiver (101) is shown in chart (801), for receiver (102) in chart (802), for receiver (103) in chart (803), and for receiver (104) in chart (804). Similarly, in FIG. 8B the final first break estimate for receiver (105) is shown in chart (805), for receiver (106) in chart (806), for receiver (107) in chart (807), and for receiver (108) in chart (808). Similarly, in FIG. 8C the final first break estimate for receiver (109) is shown in chart (809), for receiver (110) in chart (810), for receiver (111) in chart (811), for receiver (112) in chart (812), and for receiver (113) in chart (813). As shown in FIGS. 8A-8C, the final first break estimates are represented by the dash lines that are overlaid on the waveforms received by each of the receivers (101-113).

In Block 395, the radial variation of sonic slowness around the wellbore based on the tomographic inversion of the final first break estimates of the plurality of receivers is determined. Specifically, the determination of the radial variation of sonic slowness may be performed as described above. The workflow terminates after Block 395.

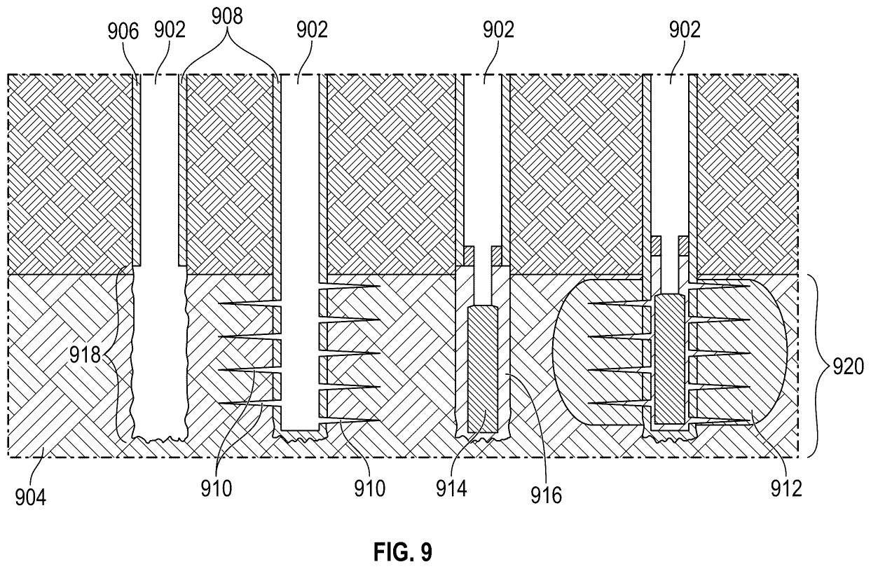

Turning to FIG. 9, FIG. 9 illustrates systems in accordance with one or more embodiments. As shown in FIG. 9, a wellbore (902) once drilled may be “completed” according to a completions plan. The completions plan may be determined based on any information about the formation (904) known at the time the completions plan is written. For example, the completions plan may be based upon the porosity and permeability of the formation (904), the rock strength and the presence or absence of natural or drilling induced fractures. Further, the completions plan may be based upon the stress field experienced by the wellbore (902) and the drilling induced damage, such as breakouts, and the presence or absence of near-wellbore formation alterations, including the invasion of drilling mud. In accordance with one or more embodiments, a sonic log and a sonic radial profile determined using data acquired with a wellbore sonic tool (200) may provide valuable information on, without limitation, the porosity, rock strength, stress field, natural and drilling induced fractures, near-wellbore alteration in the formation surrounding the wellbore, and the variation of each of these values along the length of the wellbore.

The completions plan may include casing all or part of the wellbore (902) with steel or fiberglass casing (906) and securing the casing (906) in place with cement (908), generating perforations in the casing (910), and creating hydraulic fractures (912), including multiple sectors or “stages” of hydraulic fractures (912). Further the completion plan may include a slotted liner (914), or a gravel pack (916), or both to prevent the production of sand into the future flow of hydrocarbons through the wellbore (902). In some cases, the completion plan may include a “barefoot” completion (918) where an open wellbore (902) without either casing or liner installed is used across the hydrocarbon reservoir section. In other cases, only a production liner (not shown) is installed across the hydrocarbon reservoir section (920). Furthermore, the completion plan may include the selection of artificial lift devices, including surface and downhole pumps, including electrical submersible pumps (not shown).

In accordance with one or more embodiments, once determined based, at least in part on the sonic radial profile, the completions plan may be executed. The execution of an appropriate completions plan may extend the productive life of the wellbore (902), increase the rate of production and the cumulative production of hydrocarbon fluids, and reduce the contamination of the hydrocarbon fluids by sand and other solids.

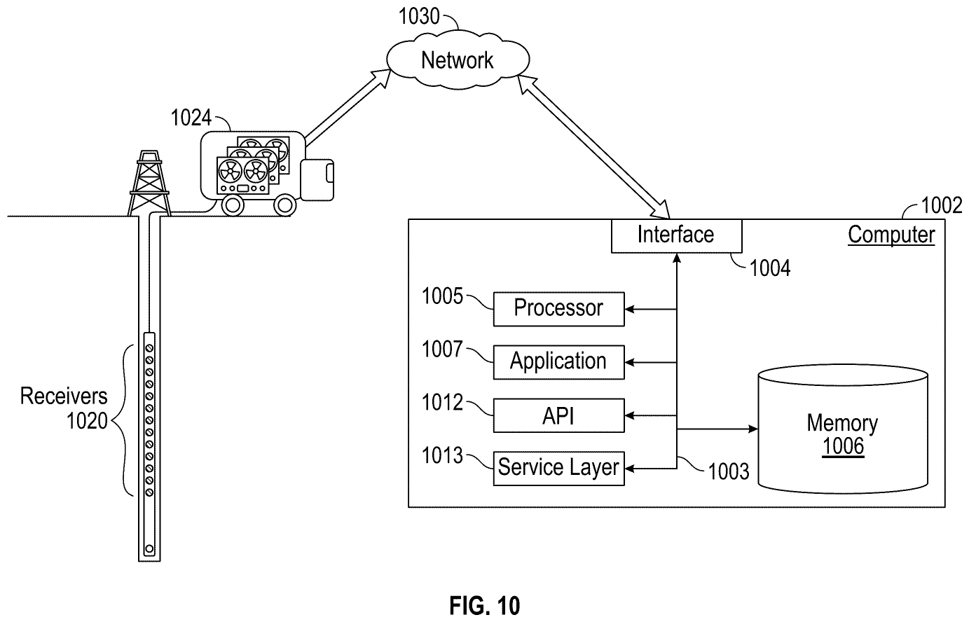

FIG. 10 shows a recording and processing system, in accordance with one or more embodiments. One or more blocks in FIG. 3 may be performed by one or more components as described in FIG. 10. The data recorded by a plurality of receivers (1020) may be transmitted to a recording facility (1024) located in the neighborhood of the wellbore (120). The recording facility may be one or more recording trucks (1024). The plurality of receivers (1020) may be in digitally or analogic telecommunication with the recording facility (1024). The telecommunication may be performed over telemetry channels that may be electrical cables, such as coaxial cables, or may be performed wireless using wireless systems, such as Wi-Fi or Bluetooth. Digitization of the sonic dataset may be performed at each receiver (1020), or at the seismic recording facility (1024), or at an intermediate telemetry node (not shown) between the receiver (1020) and the recording facility (1024).

The sonic dataset may be recorded at the recording facility (1024) and stored on non-transitory computer memory. The computer memory may be one or more computer hard-drives, or one or more computer memory tapes, or any other convenient computer memory media familiar to one skilled in the art. The sonic dataset may be transmitted to a computer (1002) for processing. The computer (1002) may be located in or near the recording facility (1024) or may be located at a remote location, that may be in another city, country, or continent. The sonic dataset may be transmitted from the recording facility (1024) to a computer (1002) for processing. The transmission may occur over a network (1030) that may be a local area network using an ethernet or Wi-Fi system, or alternatively the network (1030) may be a wide area network using an internet or intranet service. Alternatively, the sonic dataset may be transmitted over a network (1030) using satellite communication networks. Most commonly, because of its size, the sonic dataset may be transmitted by physically transporting the computer memory, such as computer tapes or hard drives, in which the sonic dataset is stored from the recording facility (1024) to the location of the computer (1002) to be used for processing.

FIG. 10 further depicts a block diagram of a computer system (1002) used to provide computational functionalities associated with described algorithms, methods, functions, processes, flows, and procedures as described in this disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. The illustrated computer (1002) is communicably coupled with a network (1030). In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002)) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (904 includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure, such as the operations in FIG. 3.

The computer (1002) also includes a memory (1006) that holds data for the computer (1002) or other components (or a combination of both) that can be connected to the network (1030). For example, memory (1006) can be a database storing data consistent with this disclosure, such as the sonic dataset and the plurality of first break estimates. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts.

1. A method for determining a set of final first breaks of a sonic dataset obtained from a sonic tool moveable within a wellbore, wherein the sonic tool comprises a source and a plurality of receivers each separated by a unique source-receiver distance, and the sonic dataset includes a plurality of traces each corresponding to a unique combination of one of the plurality of receivers and one of a plurality of source activation locations in the wellbore, the method comprising:
determining, using a computer processor, a sonic slowness log from the sonic dataset;
for each trace recorded by a subset of the plurality of receivers, using the computer processor:
determining an initial first break estimate for each trace, and
determining a second first break estimate based on an energy ratio within a time window surrounding the initial first break estimate;
for each of the plurality of traces in the sonic dataset, using the computer processor:
predicting a refined first break estimate based, at least in part, on the second first break estimates, the sonic slowness log, and an inter-receiver distance; and
determining the set of final first breaks of the sonic dataset by applying a time shift to the refined first break estimates.

2. The method of claim 1, wherein determining the initial first break estimate is based at least in part, on the unique source-receiver distance, the sonic slowness log, a wellbore diameter, and a mud slowness.

3. The method of claim 1, wherein determining a second first break estimate comprises:
determining a first time-window surrounding the initial first break estimate;
calculating a first trace energy for a second time-window preceding each time in the first time-window;
calculating a second trace energy for a third time-window following each time in the first time-window;
determining, for each time in the first time-window, an energy ratio from the first trace energy and the second trace energy; and
finding an extremum value of the energy ratios for each time within the first time-window.

4. The method of claim 3, wherein the extremum comprises maximum.

5. The method of claim 1, wherein the subset of the plurality of receivers comprises:
a near-receiver located nearest to the source;
a far-receiver located farthest from the source; and
at least one receiver located between the near-receiver and the far-receiver.

6. The method of claim 1, wherein predicting the refined first break estimate for each of the plurality of receivers and the corresponding plurality of source activation locations comprises performing a weighted interpolation based, at least in part, on the second first break estimate of the subset of the plurality of receivers and the sonic slowness log.

7. The method of claim 1, further comprising determining the radial variation of sonic slowness around the wellbore based, at least in part, on the tomographic inversion of the set of final first breaks.

8. A non-transitory computer readable medium storing instructions executable by a computer processor, the instructions comprising functionality for:
obtaining a sonic dataset from a sonic tool moveable within a wellbore, wherein the sonic tool comprises a source and a plurality of receivers each separated by a unique source-receiver distance, and the sonic dataset includes a plurality of traces each corresponding to a unique combination of one of the plurality of receivers and one of a plurality of source activation locations in the wellbore,
determining a sonic slowness log from the sonic dataset;
for each trace recorded by a subset of the plurality of receivers:
determining an initial first break estimate for each trace, and
determining a second first break estimate based on an energy ratio within a time window surrounding the initial first break estimate;
for each of the plurality of traces in the sonic dataset:
predicting a refined first break estimate based, at least in part, on the second first break estimates, the sonic slowness log, and an inter-receiver distance; and
determining the set of final first breaks of the sonic dataset by applying a time shift to the refined first break estimates.

9. The non-transitory computer readable medium of claim 8, wherein determining the initial first break estimate is based at least in part, on the unique source-receiver distance, the sonic slowness log, a wellbore diameter, and a mud slowness.

10. The non-transitory computer readable medium of claim 8, wherein determining a second first break estimate comprises:
determining a first time-window surrounding the initial first break estimate;
calculating a first trace energy for a second time-window preceding each time in the first time-window;
calculating a second trace energy for a third time-window following each time in the first time-window;
determining, for each time in the first time-window, an energy ratio from the first trace energy and the second trace energy; and
finding an extremum value of the energy ratios for each time within the first time-window.

11. The non-transitory computer readable medium of claim 10, wherein the extremum comprises maximum.

12. The non-transitory computer readable medium of claim 8, wherein the subset of the plurality of receivers comprises:
a near-receiver located nearest to the source;
a far-receiver located farthest from the source; and
at least one receiver located between the near-receiver and the far-receiver.

13. The non-transitory computer readable medium of claim 8, wherein predicting the refined first break estimate for each of the plurality of receivers and the corresponding plurality of source activation locations comprises performing a weighted interpolation based, at least in part, on the second first break estimate of the subset of the plurality of receivers and the sonic slowness log.

14. The non-transitory computer readable medium of claim 8, further comprising functionalities for determining the radial variation of sonic slowness around the wellbore based, at least in part, on the tomographic inversion of the set of final first breaks.

15. A system for determining a set of final first breaks of a sonic dataset obtained from a sonic tool moveable within a wellbore, wherein the sonic tool comprises a source and a plurality of receivers each separated by a unique source-receiver distance, and the sonic dataset includes a plurality of traces each corresponding to a unique combination of one of the plurality of receivers and one of a plurality of source activation locations in the wellbore, the system comprising:
the sonic tool to acquire the sonic dataset;
a logging acquisition system to record the sonic dataset; and
a processor configured to:
determine, a sonic slowness log from the sonic dataset;
for each trace recorded by a subset of the plurality of receivers:
determine an initial first break estimate for each trace, and
determine a second first break estimate based on an energy ratio within a time window surrounding the initial first break estimate;
for each of the plurality of traces in the sonic dataset:
predict a refined first break estimate based, at least in part, on the second first break estimates, the sonic log, and an inter-receiver distance; and
determine the set of final first breaks of the sonic dataset by applying a time shift to the refined first break estimates.

16. The system of claim 15, wherein determining the initial first break estimate is based at least in part, on the unique source-receiver distance, the sonic slowness log, a wellbore diameter, and a mud slowness.

17. The system of claim 15, wherein determining a second first break estimate comprises:
determining a first time-window surrounding the initial first break estimate;
calculating a first trace energy for a second time-window preceding each time in the first time-window;
calculating a second trace energy for a third time-window following each time in the first time-window;
determining, for each time in the first time-window, an energy ratio from the first trace energy and the second trace energy; and
finding an extremum value of the energy ratios for each time within the first time-window.

18. The system of claim 15, wherein the subset of the plurality of receivers comprises:
a near-receiver located nearest to the source;
a far-receiver located farthest from the source; and
at least one receiver located between the near-receiver and the far-receiver.

19. The system of claim 15, wherein predicting the refined first break estimate for each of the plurality of receivers and the corresponding plurality of source activation locations comprises performing a weighted interpolation based, at least in part, on the second first break estimate of the subset of the plurality of receivers and the sonic slowness log.

20. The system of claim 15, further comprising determining the radial variation of sonic slowness around the wellbore based, at least in part, on the tomographic inversion of the set of final first breaks.
